(19) United States
(12) Patent Application Publication
(10) Pub. No.: US 2022/0225621 A1
(43) Pub. Date: Jul. 21, 2022

(54) NEW FORMULATIONS OF MICROORGANISMS

(71) Applicant: BASF SE, Ludwigshafen (DE)

(72) Inventors: Rute Da Conceicao TAVARES ANDRE, Ludwigshafen (DE); Grit BAIER, Ludwigshafen (DE); Anja WIESKE, Ludwigshafen (DE); Sebastian SCHOOF, Ludwigshafen (DE); Henelyta SANTOS RIBEIRO, Ludwigshafen (DE)

(21) Appl. No.: 17/609,525

(22) PCT Filed: May 27, 2020
(86) PCT No.: PCT/EP2020/064625

§ 371 Date: Nov. 8, 2021

(30) Foreign Application Priority Data
Jun. 7, 2019 (EP) 19179045.0

(51) Int. Cl. A01N 63/20

(52) U.S. Cl. CPC A01N 63/20

(57) ABSTRACT

Polymer capsule comprising at least one polymer P1 and at least one microorganism M, wherein said polymer P1 has a solubility in water at 21° C. of at least 1 g/l and wherein said polymer capsule has an average particle size d90 of below 100 μm, wherein said microorganism M is distributed throughout said capsule.

The present invention is directed to polymer capsules comprising at least one polymer P1 and at least one microorganism M, wherein said polymer P1 has a solubility in water at 21° C. of at least 1 g/l and wherein said polymer capsule has an average particle size d90 of below 100 μm. The present invention is further directed to formulations comprising at least one microorganism M, said formulation being a water in water emulsion, wherein said emulsion contains capsules of a polymer P1 dispersed in a continuous aqueous phase containing a polymer P2, wherein said polymer P1 has a solubility in water of at least 1 g/l at 21° C. and wherein said capsules further comprise said at least one microorganism M and wherein said polymer P2 has solubility in water of at least 1 g/l at 21° C., wherein polymer P1 and polymer P2 form an aqueous two-phase system.

It is further directed to processes for making such polymer capsules and formulations and for uses of the same.

Different types of microorganisms are being widely used in many different fields of technology, for example in crop protection applications. For many applications it is beneficial to provide formulations of such microorganisms in encapsulated form, for examples encapsulated in microcapsules. Encapsulation as a way to protect the sensitive active ingredients from external stress factors (temperature, mechanical stress, light, oxidation, osmotic stress) and as way for the controlled release of the active is in principle a well-known methodology.

Several methods can be applied for encapsulating microorganisms, such as spray-drying or fluidized bed drying (coating), droplet formation over extrusion or electrospraying, polymer cross-linking or chemical polymerization as well as emulsification. Such methods are for example disclosed in:
Chavarri, M., I. Maranon, and M. Carmen, Encapsulation Technology to Protect Probiotic Bacteria. 2012;
Young, C. C., et al., Encapsulation of plant growth-promoting bacteria in alginate beads enriched with humic acid. Biotechnol. Bioeng, 2006. 95(1): p. 76-83.
Solanki, H. K., et al., Development of microencapsulation delivery system for long-term preservation of probiotics as biotherapeutics agent. Biomed Res Int, 2013. 2013: p. 620719.
Arslan, S., et al., Microencapsulation of probiotic Saccharomyces cerevisiae var. boulardii with different wall materials by spray drying. LWT—Food Science and Technology, 2015. 63(1): p. 685-690.
Semyonov, D., et al., Air-Suspension Fluidized-Bed Microencapsulation of Probiotics. Drying Technology, 2012. 30(16): p. 1918-1930

In WO 2017/087939 A1 describes the encapsulation of living organisms such as Pseudomonas fluorescens using aerosol spray methods such as electrospray.

In WO 89/07447 A1 describes the encapsulation of sporangia of Bacillus thuringiensis israelensis and their insecticidal toxins by interaction of different polymers as alginate, starch or chitosan with the bacteria cell wall.

US 2009/0269323 A1 describes the use of non-amphiphile-based water-in-water emulsion comprising a water-soluble polymer and a non-amphiphilic lyotropic mesogen which can be used for the incorporation of enzymes and is useful for inhibiting biofilm formation.

WO 2015/085899 A1 describes the preparation of water-in-water emulsions using electrospray technology and differently charged surfactants in each dispersed and continuous phase. Such emulsions are useful for the formulation of therapeutic, prophylactic and diagnostic agents.

Spray drying is a simple method in which capsules are formed and dried in one step, however the high temperatures involved in the process can lead to low viability of actives. Chemical polymerization methods usually involve presence of solvents or harsh chemicals which might not always be compatible with sensitive actives. Droplet formation through extrusion or electrospraying specially using cross-linked biopolymers as for example alginate, are quite advantageous as normally no detrimental conditions are applied. Nevertheless, particle size control is rather limited, depending on nozzle size, and small capsule sizes cannot be obtained. Typical emulsification methods usually involve formation of droplets in the interface of 2 immiscible phases, typically oil and water or a solvent and water. The use of solvents or even oils is not always compatible with microorganisms. To solidify and isolate capsules from emulsion, further crosslinking of the droplets requires additional steps with chemical agents or UV/light for polymerization or drying steps as freeze-drying, as for example disclosed in Lane, M. E., F. S. Brennan, and O. I. Corrigan, Comparison of post-emulsification freeze drying or spray drying processes for the microencapsulation of plasmid DNA. J. Pharm. Pharmacol., 2005. 57(7): p. 831-8.

In another known technique, microcapsules are being prepared from emulsion systems in which microcapsules are being formed, for example in polymerization and/or crosslinking reactions. Typically, high shear is needed to achieve small homogenously dispersed particle sizes. Systems as colloid mills, rotor-stator or high-pressure homogenizers are typically used. Such mechanical stress is often detrimental for biological actives. Also, the preparation of polymeric capsule shells in many cases requires high temperatures or chemically reactive starting materials like isocyanates.

Therefore, it is a challenge to prepare capsules of substrates such as microorganisms, especially if they are sensitive to heat, high shear forces or reactive groups like isocyanates and that contain a high number of intact microorganisms and there is a demand for microcapsules comprising such microorganisms.

All-aqueous emulsions, also known as water-in-water (W/W) emulsions, are colloidal dispersions formed in mixtures of at least two macromolecules, which are thermodynamically incompatible in solution, generating two immiscible phases. The phase separation exhibits interesting rheological properties and are characterized by an extremely low interfacial tension generally between 10-4 and 10-6 N/m, quite lower than typical oil and water systems (compare Scholten, E., et al., Interfacial Tension of a Decomposed Biopolymer Mixture. Langmuir, 2002(18): p. 2234-2238).

Jordi Esquena performed a thorough review on the physical-chemistry of water-in-water emulsions and their applications (J. Esquena, Water-in-water (W/W) emulsions, Current Opinion in Colloid & Interface Science, 2016 (23): p. 109-119).

It was therefore an objective of the present invention to provide polymer capsules of microorganisms with small capsule sizes, formulations comprising the same as well as processes for making such capsules and formulations.

The objective has been achieved by polymer capsules comprising at least one polymer P1 and at least one microorganism M, wherein said polymer P1 has a solubility in water at 21° C. of at least 1 g/l and wherein said polymer capsule has an average particle size d90 of below 100 μm.

Said microorganism M is preferably selected from gram-positive or gram-negative bacteria, fungal spore, mycelia, yeasts, bacteriophages or other viruses.

In one embodiment, said microorganism is sensitive to high shear forces (meaning shear forces as they typically occur in an Ultraturrax or above 1200 Pa), to high temperatures (for example to temperatures above 20° C.) and/or non-aqueous chemical components such as organic solvents or oils or to reactive groups such as isocyanate groups that are sometimes comprised in reactive monomers.

“Sensitive” in this context means a decrease of at least 20% of vitality (meaning a decrease of the CFU per g units) per minute when exposed to high shear forces, temperatures above 40° C. or non-aqueous solvents.

In one embodiment, microorganisms M are non-spore forming bacteria.

In one embodiment, microorganisms M are gram-positive bacteria, gram-negative bacteria, fungal spore, fungal mycelia, yeasts, bacteriophages or other viruses.

In one embodiment, microorganisms M are gram-negative bacteria, fungal spore, fungal mycelia, yeasts, bacteriophages or other viruses.

Specific examples of microorganisms M include the following:
Microbial pesticides with fungicidal, bactericidal, viricidal and/or plant defense activator activity: Ampelomyces quisqualis, Aspergillus flavus, Aureobasidium pullulans, Bacillus altitudinis, B. amyloliquefaciens, B. megaterium, B. mojavensis, B. mycoides, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus alvei, Paenibacillus polymyxa, P. agglomerans, Pantoea vagans, Penicillium bilaiae, Phlebiopsis gigantea, Pseudomonas sp., Pseudomonas chlororaphis, P. fluorescens, P. putida, Pseudozyma flocculosa, Pichia anomala, Pythium oligandrum, Sphaerodes mycoparasitica, Streptomyces griseoviridis, S. lydicus, S. violaceusniger, Talaromyces flavus, Trichoderma asperellum, T. atroviride, T. fertile, T. gamsii, T. harmatum, T. harzianum, T. polysporum, T. stromaticum, T. virens, T. viride, Typhula phacorrhiza, Ulocladium oudemansii, Verticillium dahlia, zucchini yellow mosaic virus (avirulent strain);
Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium or sodium bicarbonate, Reynoutria sachalinensis extract, salicylic acid, tea tree oil;
Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia spp., Chromobacterium subtsugae, Cydia pomonella granulovirus (CpGV), Cryptophlebia leucotreta granulovirus (CrleGV), Flavobacterium spp., Helicoverpa armigera nucleopolyhedrovirus (HearNPV), Heterorhabditis bacteriophora, Isaria fumosorosea, Lecanicillium longisporum, L. muscarium, Metarhizium anisopliae, Metarhizium anisopliae var. anisopliae, M. anisopliae var. acridum, Nomuraea rileyi, Paecilomyces lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus (SpliNPV), Steinernema carpocapsae, S. feltiae, S. kraussei, Streptomyces galbus, S. microflavus; Metharhizium species; Rhizobium and Bradyrhizobium species, Clostridium species.
Plant growth promoter microbes: Metharhizium species; Rhizobium and Bradyrhizobium species; Acinectobacter species; Pseudomonas species; Bacillus species; Penicillum species; Aspergillus species; Fusarium species; Trichoderma species.

Preferred microorganisms M bacteria: Bacillus subtilis, Bacillus velezensis, Bacillus amyloliquefaciens, Bacillus firmus, Bacillus pumilus, Bacillus simplex, Paenibacillus polymyxa, Bacillus megaterium, Bacillus aryabhattai, Bacillus thuringiensis, Bacillus megaterium, Bacillus aryabhattai, Bacillus altitudinis, Bacillus mycoides, Bacillus toyonensis, Bacillus safensis, Bacillus methylotrophicus, Bacillus mojavensis, Bacillus psychrosaccharolyticus, Bacillus galliciensis, Bacillus lentus, Bacillus siamensis, Bacillus tequilensis, Bacillus firmus, Bacillus aerophilus, Bacillus altitudinis, Bacillus stratosphericus, Bacillus velezensis, Brevibacillus brevis, Brevibacillus formosus, Brevibacillus laterosporus, Brevibacillus nitrificans, Brevibacillus agri, Brevibacillus borstelensis, Lysinibacillus xylanilyticus, Lysinibacillus parviboronicapiens, Lysinibacillus sphaericus, Lysinibacillus fusiformis, Lysinibacillus boronitolerans, Paenibacillus alvei, Paenibacillus Validus, Paenibacillus amylolyticus, Paenibacillus lautus, Paenibacillus peoriae, Paenibacillus tundrae, Paenibacillus daejeonensis, Paenibacillus alginolyticus, Paenibacillus pini, Paenibacillus odorifer, Paenibacillus endophyticus, Paenibacillus xylanexedens, Paenibacillus illinoisensis, Paenibacillus thiaminolyticus, Paenibacillus barcinonensis, Sporosarcina globispora, Sporosarcina aquimarina, Sporosarcina psychrophila, Sporosarcina pasteurii, Sporosarcina saromensis, Paenibacillus spp., Lactobacillus species., Rhizobium and Bradyrhizobium species, Clostridium species.

Preferred microorganisms M are Bacillus subtilis, Bacillus velezensis, Bacillus amyloliquefaciens, Bacillus firmus, Bacillus pumilus, Bacillus simplex, Paenibacillus polymyxa and Bacillus thuringiensis, Rhizobium and Bradyrhizobium species, Beauveria bassiana.

It is one of the advantages of the present invention that microcapsules, in particular microcapsules with an average diameter d90 of 100 μm or less can be prepared of such microorganisms that are sensitive to high shear forces, high temperatures or certain nonaqueous chemicals without observing decomposition of significant parts of such sensitive microorganisms. In particular microcapsules of such sensitive microorganisms can be prepared containing high numbers of colony forming units (cfu) of such microorganisms is such microcapsules. In particular, it is possible to prepare microcapsules of such sensitive microorganisms with a number of cfu/g of 1E+08 or above, 1E+09 or above or even 1E+10 or above.

The method for determining the cfu number is known to the skilled person and is carried according to standard procedures as described in the experimental part.

Said polymer P1 can in principle be any polymer having the required solubility in water and that is capable of forming solid capsules at room temperature. Preferably polymers P1 are biodegradable.

In one embodiment, polymer P1 is selected from dextran, starch, alginate, guar gum, pectin, gelatin, casein, polyvinyl alcohol, polyvinylpyrrolidone, polyethylene glycol, caseinate, Maltodextrin, Carrageenan, dextran, xanthan gum, gum Arabic or modified cellulose (like hydroxypropyl cellulose or carboxymethylcellulose) or mixtures thereof.

In one embodiment, polymer P1 is selected from dextran, starch, alginate, pectin, gelatin, casein, polyvinyl alcohol (PVA), polyvinylpyrrolidone (PVP), polyethylene glycol (PEG), caseinate, maltodextrin, carrageenan, dextran, gum Arabic or modified cellulose or mixtures thereof. Examples of modified cellulose are hydroxypropyl cellulose or carboxymethylcellulose.

In one embodiment, polymer P1 is selected from dextran, starch, alginate, guar gum, pectin, gelatin, casein, xanthan gum, polyvinyl alcohol, polyvinylpyrrolidone, modified cellulose (like hydroxypropyl cellulose or carboxymethylcellulose) or mixtures thereof.

Preferably, said polymer P1 is selected from dextran, starch, alginate, gelatin, pectin, casein, polyvinyl alcohol and polyvinylpyrrolidone or mixtures thereof.

When reference is made herein to a polymer particle or an aqueous solution comprising “a polymer P1” (or analogously polymer P2), this shall include also polymer particles or aqueous solutions comprising one type of polymer or mixtures of two or more polymers P1.

In one embodiment said polymer P1 as comprised in polymer capsules according to the invention has been subjected to a solidification or crosslinking.

In the context of this invention, when reference is made to “polymer P1”, this shall, depending on the context, include the unmodified polymer P1 as well polymer P1 that has been subjected to solidification or crosslinking.

Such solidification or crosslinking can for example have been induced by a crosslinking agent, or through temperature changes, pH changes or by osmotic drying.

Said solidifying or crosslinking enhances the mechanical stability of said capsules and can prevent or delay the dissolution of capsules according to the invention upon mixture with water. Solidification of capsules further facilitates the isolation of such capsules in a dry product form which can inter alia extend product shelf-life. Cross-linking the matrix of polymer P1 reduces mobility of the encapsulated active (microorganism) which can improve its stability/shelf-life.

Different types of polymers P1 can be subjected to different types of solidification or crosslinking reactions. In many cases, said solidification or crosslinking reaction is effected by a solidification or crosslinking agent A. Said agent A can for example be a salt of a divalent cation like a calcium salt, an acid such as tannic acid or citric acid, a base such as such as sodium hydroxide or potassium hydroxide, an aldehyde such as glutaraldehyde or dextran aldehyde, a phosphate such as tripolyphosphate or trisodium metaphosphate, an enzyme such as transglutaminase, a carbodiimide such as 1-ethyl-3-(3-dimethylaminopropyl)carbodiimide (EDC), a succinimide like N-hydroxy succinimide (NHS) or genipin, borates, titanates, zirconates, cyanoborohydrides such as sodium cyanoborohydride.

Typical borates, titanates and zirconates in the context of this invention can be inorganic salts of boric acid or inorganic titanates or inorganic zirconates or organic borates, titanates or zirconates.

In case polymer P1 is alginate or pectin, agent A can for example be salts of divalent cations, e.g. calcium salts like calcium chloride.

In case polymer P1 is PVP, PVA, PEG or polysaccharides, agent A can for example be an acid, such as tannic acid or citric acid.

In case polymer P1 is chitosan, agent A can for example be a base such as sodium hydroxide or potassium hydroxide.

In case polymer P1 is a protein (such as pectin, gelatin, casein), agent A can for example be an aldehyde such as glutaraldehyde or dextran aldehyde.

In case polymer P1 is a polysaccharide, agent A can for example be a phosphate, e.g. sodium tripolyphosphate or sodium trimetaphosphate or monosodium phosphate.

In case polymer P1 is a protein or chitosan or pectin, agent A can be an enzyme, such as transglutaminase.

In case polymer P1 is a protein or a polysaccharide, agent A can for example be genipin, a carbodiimide such as 1-ethyl-3-(3-dimethylaminopropyl)carbodiimide (EDC), a succinimide like N-hydroxy succinimide (NHS).

In case polymer P1 is a gum (such as Guar Gum or xanthan gum), a modified cellulose (such as hydroxypropyl cellulose or carboxymethylcellulose) or polyvinyl alcohol, agent A can for example be a borate, titanate or zirconate.

In case polymer P1 is a protein or a polysaccharide, said polymer P1 can be crosslinked by a reductive amination that involves the conversion of a carbonyl group to an amine via an intermediate imine. Said carbonyl group is most commonly an aldehyde. Suitable agents A for this process are known to the skilled person and include for example cyanoborohydrides such as sodium cyanoborohydride.

Agent A is preferably selected from divalent cations such as Calcium (especially in case polymer P1 is alginate or pectin), acids such as tannic acid or citric acid (especially in case polymer P1 is PVP, PEG, PVA or polysaccharides), bases such as NaOH or KOH (especially in case polymer P1 is Chitosan), aldehydes (especially in case polymer P1 is a protein), phosphates such sodium trimetaphosphate, monosodium phosphate or sodium tripolyphosphate (especially in case polymer P1 is a polysaccharide), enzymes such as transglutaminase (especially in case polymer P1 is a protein or a chitosan or pectin), genipin, carbodiimides or succinimides (for genipin, carbodiimides and succinimides especially for polymer P1 being proteins and polysaccharides), borates, titanates or zirconates (for borates, titanates or zirconates, especially in case polymer P1 is a gum (such as Guar Gum or xanthan gum), a modified cellulose (such as hydroxypropyl cellulose or carboxymethylcellulose) or polyvinyl alcohol), cyanoborohydrides (especially polymer P1 is a protein or a polysaccharide).

In the case of a solidification reaction, for example induced by calcium salts, a hydrogel matrix is formed. The formation of such hydrogel matrix can be stopped or reversed by addition of chelating molecules (such as citric acid or EDTA) that can dissolve such hydrogel matrix. In other cases the polymer capsules can be solidified through the removal of water caused by osmotic pressure difference between the two polymer phases (for example, starch and PEG phases).

In other cases, for example when the polymer is being crosslinked, for example by an aldehyde, the nature of polymer P1 is chemically modified, due to covalent crosslinking.

Polymer capsules according to the invention preferably have an average particle size d90 of below 100 μm. In one embodiment, polymer capsules preferably have an average particle size d90 of below 50 μm. In one embodiment the average capsule size d90 is 1 to 100 μm or 10 to 100 μm or 10 to 50 μm.

Particle sizes of polymer capsules as used in this application are determined by laser diffraction according to ISO13320:2009

Polymer capsules according to the invention normally comprise said microorganism M distributed throughout said polymer P1. Polymer capsules according to the invention are thus normally distinct from core-shell capsules that comprise the active in the core of the capsule and a polymer in the shell. The distribution of microorganism M in the capsule can for example be observed by fluorescence microscopy.

Capsules according to the invention may further comprise further formulation additives that promote stability of encapsulated actives such as saccharides and polysaccharides (trehalose, lactose), proteins, polymers (amphiphilic polymers, salts, polyols, amino acids, antioxidants (for example ascorbic acid, tocopherol), buffers, osmeoprotectants, buffers, salts for pH and osmotic control; fillers (like silica, kaolin, CaCO₃):

In one embodiment, capsules according to the invention comprise a protective colloid or pickering particles. Examples of protective colloids and pickering particles include proteins, nanoparticles of silica or clay, polymer particles.

The present invention is further directed to formulations comprising at least one encapsulated substrate, said formulation being a water in water emulsion, wherein said emulsion contains capsules of a polymer P1 dispersed in a continuous aqueous phase containing a polymer P2, wherein said polymer P1 has a solubility in water of at least 1 g/l at 21° C. and wherein said capsules further comprise said at least one substrate and wherein said polymer P2 has solubility in water of at least 1 g/l at 21° C., wherein polymer P1 and polymer P2 form an aqueous two-phase system.

The present invention is further directed to formulations comprising at least one microorganism M, said formulation being a water in water emulsion, wherein said emulsion contains capsules of a polymer P1 dispersed in a continuous aqueous phase containing a polymer P2, wherein said polymer P1 has a solubility in water of at least 1 g/l at 21° C. and wherein said capsules further comprise said at least one microorganism M and wherein said polymer P2 has solubility in water of at least 1 g/l at 21° C., wherein polymer P1 and polymer P2 form an aqueous two-phase system.

In one embodiment, microorganisms M are present in such formulation only in such capsules of polymer P1.

In one embodiment, microorganisms M that are present in such formulation in such capsules of polymer P1 are not present in the formulation outside such capsules of polymer P1.

Aqueous two-phase systems, also known as water-in-water emulsions or W/W emulsions, are in principle known to the skilled person. The high degree of polymerization of the molecules that form aqueous two-phase systems (proteins, polysaccharides) lead to many solvent-polymer and polymer-polymer contacts per polymer chain. While the contacts between polymer and solvent are favorable in case of a good solvent, the contacts between the two different polymers are generally unfavorable. As a result, the mixing enthalpy of two different polymers is often positive and cannot be compensated by the mixing entropy. As the number of polymer-polymer contacts and consequently the mixing enthalpy depends strongly on polymer concentration, phase separation is observed only above a critical demixing concentration. The critical demixing concentration depends not only on the specific combination of two polymers, but also on their molar masses. Upon increase of the molar masses, the mixing entropy decreases with respect to the mixing enthalpy, so demixing occurs already at lower concentrations.

Suitable and preferred microorganisms M in formulations according to the invention are identical to those disclosed above.

Suitable pairs of polymers P1 and P2 can in principle be all polymers that have the required solubility in water provided that polymers P1 and P2 are not compatible. “Compatible” means that polymer P1 and P2 and not miscible but, although both being soluble in water, form two separate phases. Polymer P1 needs to be capable of forming solid capsules at room temperature by itself of after solidifications as described below.

In one embodiment, polymers P1 and P2 are each selected from dextran, starch, alginate, guar gum, pectin, gelatin, casein, polyvinyl alcohol, polyvinylpyrrolidone, polyethylene glycol, caseinate, Maltodextrin, Carrageenan, dextran, xanthan gum, gum Arabic or modified cellulose (like hydroxypropyl cellulose or carboxymethylcellulose) or mixtures thereof.

Preferably, polymers P1 and P2 are each selected from dextran, starch, alginate, pectin, gelatin, casein, polyvinyl alcohol, polyvinylpyrrolidone, polyethylene glycol, caseinate, Maltodextrin, Carrageenan, dextran, gum Arabic or modified cellulose (like hydroxypropyl cellulose or carboxymethylcellulose) or mixtures thereof.

In one embodiment, polymer P1 is selected from dextran, starch, alginate, guar gum, pectin, gelatin, casein, xanthan gum, polyvinyl alcohol, polyvinylpyrrolidone, modified cellulose (like hydroxypropyl cellulose or carboxymethylcellulose) or mixtures thereof.

Preferably, polymer P1 is selected from dextran, starch, alginate, gelatin, pectin, casein, polyvinyl alcohol and polyvinylpyrrolidone or mixtures thereof.

In one embodiment polymers P1 and P2 are selected from the following combinations of polymer P1 and polymer P2:

| Polymer P1 | Polymer P2 |
|---|---|
| Dextran | Polyethylene glycol |
| Starch | Polyethylene glycol |
| Alginate | Caseinate |
| Alginate | Polyethylene glycol |
| Gelatin | Maltodextrin |
| Gelatin | Carrageenan |
| Gelatin | Modified cellulose like |
| | hydroxypropyl cellulose or |
| | carboxymethylcellulose |
| Gelatin | Dextran |
| Casein | Pectin |
| Gelatin | Gum Arabic |
| Polyvinyl alcohol | Polyethylene glycol |
| Polyvinyl alcohol | Polyvinylpyrrolidone |
| Polyvinylpyrrolidone | Polyethylene glycol |
| Guar gum | Polyethylene glycol |
| Guar gum | Polyvinylpyrrolidone |
| Xanthan gum | Polyethylene glycol |
| Modified cellulose like | Polyethylene glycol |
| hydroxypropyl cellulose or | |
| carboxymethylcellulose | |
| Modified cellulose like | Polyvinylpyrrolidone |
| hydroxypropyl cellulose or | |
| carboxymethylcellulose | |
| Modified cellulose like | Casein |
| hydroxypropylcellulose or | |
| carboxymethylcellulose | |

Preferably, polymers P1 and P2 are selected from the following combinations of polymer P1 and polymer P2:

| Polymer P1 | Polymer P2 |
|---|---|
| Dextran | Polyethylene glycol |
| Starch | Polyethylene glycol |
| Alginate | Caseinate |
| Gelatin | Maltodextrin |
| Gelatin | Carrageenan |
| Gelatin | Modified cellulose like |
| | hydroxypropyl cellulose or |
| | carboxymethylcellulose |
| Gelatin | Dextran |
| Casein | Pectin |
| Gelatin | Gum Arabic |
| Polyvinyl alcohol | Polyethylene glycol |
| Polyvinyl alcohol | Polyvinylpyrrolidone |
| Polyvinylpyrrolidone | Polyethylene glycol |

In one embodiment, polymers P1 and P2 are selected from the following combinations of polymer P1 and polymer P2:

| Polymer P1 | Polymer P2 |
|---|---|
| Starch | Polyethylene glycol |
| Alginate | Caseinate |
| Casein | Pectin |
| Gelatin | Gum Arabic |
| Modified cellulose like | Casein |
| hydroxypropyl cellulose or | |
| carboxymethylcellulose | |

In principle the size of the polymer capsules comprised in formulations according to the invention is not limited to any particular size. Preferably, the average capsule size (number average, d90) is below 400 μm.

More preferably said average capsule size is below 100 μm.

In one embodiment said average capsule size is below 50 μm.

In one embodiment the capsule size is 1 to 400 μm or 1 to 100 μm or 10 to 100 μm or 10 to 50 μm.

In one embodiment said polymer P1 has been subjected to a solidification or crosslinking. Such solidification or crosslinking can for example have been induced by an agent A or through temperature changes, pH changes or by osmotic drying, as described above.

The droplet phase, i.e. the capsules of polymer P1 can also include other formulation additives that promote stability of encapsulated actives such as saccharides and polysaccharides (trehalose, lactose), proteins, polymers (amphiphilic polymers,), salts, polyols, amino acids, antioxidants (for example ascorbic acid, tocopherol), buffers, osmeoprotectants, buffers, salts for pH and osmotic control; fillers (like silica, kaolin, CaCO₃).

Preferably, said continuous phase further contains at least one emulsifier.

In one embodiment, said polymer capsules comprise a protective colloid or pickering particles. Examples of protective colloids and pickering particles include proteins, nanoparticles of silica or clay, polymer particles.

The droplet phase and/or the continuous phase may also include salts or components used to adjust ionic strength of solutions and induce phase separation.

Each phase may contain more than one polymer as long as phase separation is present.

Another aspect of the present invention are processes for preparing capsules comprising a polymer P1 and a substrate, wherein said polymer P1 has a solubility in water of at least 1 g/l at 21°, said process comprising the following steps:
A) Providing a droplet phase, said droplet phase being an aqueous solution of polymer P1 and further comprising a substrate dispersed in the aqueous medium;
B) Providing a continuous phase, said continuous phase being an aqueous solution of a polymer P2, optionally further comprising an emulsifier;
C) Bringing said droplet phase and said continuous phase into contact through the pores of a membrane while otherwise being separated by such membrane,
D) Creating a flow of said droplet phase into said continuous phase through the pores of said membrane,

wherein said polymer P2 has solubility in water of at least 1 g/l at 21° C., wherein polymer P1 and polymer P2 form an aqueous two-phase system.

Typically said dispersed substrate has a number average particle size that is at least by a factor 10 smaller than the average size of the pores of said membrane

Another aspect of the present invention are processes for preparing capsules comprising a polymer P1 and a microorganism M, wherein said polymer P1 has a solubility in water of at least 1 g/l at 21°, said process comprising the following steps:
A) Providing a droplet phase, said droplet phase being an aqueous solution of polymer P1 and further comprising a microorganism M dispersed in the aqueous medium;
B) Providing a continuous phase, said continuous phase being an aqueous solution of a polymer P2, optionally further comprising an emulsifier;
C) Bringing said droplet phase and said continuous phase into contact through the pores of a membrane while otherwise being separated by such membrane,
D) Creating a flow of said droplet phase into said continuous phase through the pores of said membrane,

wherein said polymer P2 has solubility in water of at least 1 g/l at 21° C., wherein polymer P1 and polymer P2 form an aqueous two-phase system.

The droplet phase can also include other formulation additives that promote stability of encapsulated actives such as saccharides and polysaccharides (trehalose, lactose), proteins, polymers (amphiphilic polymers), salts, polyols, amino acids, antioxidants (for example ascorbic acid, tocopherol), buffers, osmeoprotectants, buffers, salts for pH and osmotic control; fillers (like silica, kaolin, CaCO₃).

Processes according to the invention involve application of low pressure for dosing the droplet phase through a membrane with droplet detachment into the continuous phase. The droplet size can be controlled through the membrane pore size, droplet phase flow, and shear applied on the membrane surface. The shear on the membrane surface can for example be induced by stirring or cross-flow of the continuous phase or by rotation or oscillation of the membrane.

Productivity for this technology can go up to L/min, making it industrially relevant.

Said membrane that separates the droplet phase and the continuous phase comprises pores of a defined size and shape that allow for a flow of the droplet phase into the continuous phase. Through the size of the pores comprised in the membrane, the size of the capsules of polymer P1 and comprising microorganism M obtained can be controlled. Smaller pore size normally yield smaller polymer capsules. Typically, the membrane pores have a number average pore size of 1 to 400 μm, preferably 5 to 400 μm. In one embodiment the number average pores size is 5 to 100 μm, 10 to 100 μm, 20 to 100 μm or 5 to 40 μm or 10 to 40 μm.

Preferably, the pores comprised in said membrane have a narrow pore size distribution. While said membrane can in principle be made of any material that is inert to the components of the formulation, it turned out that membranes made of organic polymers often have a broader pore size distribution. Membranes made of organic polymers are therefore less preferred.

In one preferred embodiment, said membrane is made of glass or metal, e.g. steel. It is also possible that such glass or metal membranes are subjected to a surface treatment to enhance the surface properties of such membrane. For example, it is possible to enhance the hydrophobic properties of a membranes through methods known to the skilled person. Examples of such surface treatment of membranes include the treatment with polytetrafluoroethylene, fluoroalkyl silanes, silanization reaction on the surface.

In one embodiment, said membrane emulsification equipment includes an oscillating membrane, a rotating membrane or a static membrane.

The emulsion can be further preserved as is or the formed capsules can be isolated e.g. through centrifugation or filtration and optionally further dried. Drying methods include, but are not limited to, convective drying or fluidized bed drying. Through isolation of the formed capsules, e.g. by centrifugation or filtration and optionally further drying, microcapsules can be obtained that are “dry”, meaning that they are not dispersed in a solvent. Such dry capsules typically comprise less than 50 wt % of water or other solvents, preferably less than 20 wt %, more preferably less than 10 wt % and even more preferably less than 5 wt % (in each case based on the mixture). Such dry capsules can be stored and can be used as is or can be redispersed in a solvent, preferably an aqueous solvent, prior to use.

In one embodiment, said process further comprises the following steps:
E) Physically separating the capsules obtained in step D) from the continuous phase (e.g. by filtration or centrifugation),
F) Optionally drying the capsules obtained in step E).

In one preferred embodiment said polymer P1 is been subjected to a solidification or crosslinking after step D) and, if applicable, prior to step E).

Different types of polymers P1 can be subjected to different types of solidification or crosslinking reactions.

In one embodiment and depending on the nature of polymer P1 and microorganism M, the formulation is subjected to a higher temperature to achieve solidification or crosslinking of polymer P1.

In another embodiment such solidification is achieved through the presence of an agent A, that induces solidification or crosslinking of polymer P1. Examples of suitable solidification agents A are disclosed above.

In one embodiment, agent A is present in the continuous phase throughout the process.

In one embodiment, agent A is added to the continuous phase after step D) and, if applicable, prior to step E).

In one embodiment, said continuous phase optionally further contains at least one emulsifier.

In one embodiment, said polymer capsules comprise a protective colloid or pickering particles as described above.

In principle the size of the polymer capsules obtained in processes according to the invention is not limited to any particular size. In one embodiment, the average capsule size (number average, d90) is below 400 μm.

More preferably said average capsule size is below 100 μm.

In one embodiment said average capsule size is below 50 μm.

In one embodiment the capsule size is 1 to 400 μm or 1 to 100 μm or 10 to 50 μm.

Capsules and formulations according to the invention can for example be used in crop protection applications.

Capsules and formulations according to the invention may further comprise, comprised in the droplet phase or the continuous phase, one or more further pesticides (e.g. herbicides, insecticides, fungicides, growth regulators, safeners).

Another aspect of the present invention is a method of controlling phytopathogenic fungi and/or undesired plant growth and/or undesired insect or mite attack and/or for regulating the growth of plants, wherein the capsules according to the invention, formulations according to the invention or capsules or formulations prepared according to processes according to the invention are allowed to act on the respective pests, their environment or the crop plants to be protected from the respective pest, on the soil and/or on undesired plants and/or on the crop plants and/or on their environment.

Capsules and formulations according to the invention can be applied in plant protection formulations for example in spray applications (ready mix or resuspended in tank-mix), seed coatings or in furrow:

Processes according to the invention allow for the manufacture of encapsulated microorganisms that are sensitive to shear forces, temperature and/or reactive chemical groups. Capsules with small capsule sizes can be produced.

Capsules and formulations according to the invention are easy and economical to make and are very stable during storage.

The found capsules, formulations and processes allow for a high survivability and prolonged shelf-life of the encapsulated microorganisms.

Capsules and formulations according to the invention can be prepared with a low shear stress or even without any shear, at low energy input per unit volume compared to conventional emulsion methods, allowing therefore good control and homogeneity of droplet size.

### EXAMPLES

Materials Used:

Bradyrhizobium japonicum 532c USDA442 soluble starch: soluble potato starch acc. to Zullkowsky (Sigma-Aldrich—Prod. Nr. 85642) PEG with Mw 8000 (Fisher Scientific): Polyethylene glycol, MW calculated from OH number. PEG with Mw 20 000 (Merck): Polyethylene glycol, MW calculated from OH number.

Preparation of B. japonicum Cultures:

Bradyrhizobium japonicum were prepared via batch fermentation as follows: a 2 L PETG (Nalgene) seed shake flask containing 500 mL of a generic medium such as yeast mannitol broth (YMB) was used. The shake flask was sterile inoculated via a glycerol stock or interchangeably a slant media wash or agar plate scrape. The flask was placed in an incubator at temperatures between 26-32° C. The flask was shaken at medium speed for 4-7 days. A stainless steel fermenter containing 20 L generic Rhizobia media was inoculated. The fermentation was run in batch mode with low agitation and aeration for 14 days or until after steady state was reached. Media was aseptically harvested and filled into sterilized plastic bladders at 4° C. until use. Bradyrhizobium japonicum strain 532c was obtained from a generic Rhizobia media e.g. containing complex raw materials, a nitrogen and carbon source, salts, vitamins and trace elements as well as a small amount of antifoam with pH between 5.5 and 7.5. The media also contained 50 g/L trehalose.

### Examples 1 to 3: Preparation of Capsules Containing Bradyrhizobium Japonicum in a Starch/PEG System

The droplet phase was prepared by mixing the cultivation broth of B. japonicum 532c obtained as described above with an aqueous solution of soluble starch to a concentration of 15% (w/v) starch.

The continuous phase consists of a 50% (w/v) aqueous solution of PEG with Mw 8000 or Mw 20 000 (M_{W} calculated from the OH number).

All examples were prepared using a Dispersion Cell (Micropore, UK) as membrane emulsification equipment, with a hydrophobic stainless-steel membrane with pore size of 40 μm and 200 μm pitch. Droplet phase flow was adjusted to 200 μL/min and shear of 4V. A ratio of 1:2 droplet phase/continuous phase was used.

Capsule solidification was achieved by osmo-solidification. The emulsion was left under agitation for 1 hour at room temperature. After this the emulsion was centrifuged for 10 min at 5° C. and 3500 RPM. The capsules were either washed two times with water or further processed as is. The capsule pellet was dried overnight at ambient conditions.

### Example 4 (Comparative Example)

The droplet phase was prepared by mixing the cultivation broth of B. japonicum 532c with an aqueous solution of soluble starch to a concentration of 30% (w/v) starch. The continuous phase consists of an aqueous solution of PEG (Sigma-Aldrich) with Mw 8000. Both solutions were brought together and homogenized for 1 minute with a Ultraturrax

### Example 5 (Comparative Example)

A solution was prepared by mixing the cultivation broth of B. japonicum 532c with an aqueous solution of soluble starch to a concentration of 30% (w/v) starch. This solution was spray-dried in a lab scale spray-dryer Büchi-290 under following conditions: 110° C. inlet temperature; 70° C. outlet temperature; 25 m³/h drying gas flow rate; 2.65 mL/min feed flow.

### Example 6: Shelf Life

For shelf-life tests, samples were stored in aluminum bottles in an incubator with controlled temperature (28° C.).

The viability of bacteria was tested by determining the colony forming units (CFU) in agar medium as follows: A 0.025 g of powder sample is weighed out in a conical tube and mixed with 1 mL of Peptone buffer and vortexed for 5 seconds and agitated in a rolling tray for 2 hours. Several dilutions were prepared. Samples from each dilution were pipetted on the surface of Congo Red Yeast Mannitol Agar (CRYMA) spot plates to create 10 μL spots per dilution. Samples are absorbed into the agar for 10-15 minutes and incubated for 7 days at 28° C. After incubation of plates, visible colonies are counted. Results are calculated in CFU/mL or CFU/g sample according to the respective dilution factor.

Particle Size Analysis:

Particle size was analyzed by dynamic light scattering (Beckman Coulter LS 13 320). Particle sizes in Table below were determined in the emulsion after solidification step.

| | | | | | | Viability | Viability | Particle |
|---|---|---|---|---|---|---|---|---|
| | | | | Viability | Viability | after 56 | after 112 | Size in |
| | Droplet | Continuous | | in starting | after | days at | days at | Emulsion |
| | phase | phase | Capsule | solution | processing | 28° C. | 28° C. | D90 |
| Example | composition | composition | treatment | (CFU/mL) | (CFU/g) | (CFU/g) | (CFU/g) | (μm) |
| 1 | 15% | 50% PEG | washed | 4.00E+09 | 5.36E+08 | — | 2.08E+08 | 62.7 |
| | starch | 8000 | | | | | | |
| 2 | 15% | 50% PEG | not | 4.67E+09 | 2.59E+08 | — | 1.59E+07 | 53.9 |
| | Starch | 20000 | washed | | | | | |
| 3 | 15% | 50% PEG | washed | 4.67E+09 | 7.81E+09 | — | 7.91E+08 | |
| | Starch | 20000 | | | | | | |
| 4 | 30% | 50% PEG | not | 8.33E+09 | 2.89E+05 | 9.68E+03 | — | 78.8 |
| | Starch | 8000 | washed | | | | | |

| | | | | | | | |
|---|---|---|---|---|---|---|---|
| 5 | 30% starch | no | 5.33E+10 | 7.80E+08 | 6.85E+05 | — | — |
| | | treatment | | | | | |

### Example 7: Examples of Further Water-In-Water Emulsion Systems Possible for the Production of Capsules

The droplet phase was prepared by mixing aqueous solutions of Polymer 1 in the concentrations as indicated in the Table below. The continuous phase consists of aqueous solution of Polymer 2 in concentrations as indicated in the Table below.

All examples were prepared using a Dispersion Cell (Micropore, UK) as membrane emulsification equipment, with a hydrophobic stainless-steel membrane with pore size of 40 μm and 200 μm pitch. Droplet phase flow was adjusted to 200 μL/min and shear of 4V. A ratio of 1:2 droplet phase/continuous phase was used.

It was then visually evaluated with the help of a light microscope (Leica DM 2700M) if dispersed droplets/particles were present in the continuous phase and thus a water in water emulsion was formed.

| | | Emulsion was |
|---|---|---|
| Polymer 1 | Polymer 2 | formed |
| 2.5% Alginate | 10% Na-Caseinate | Yes |
| 2.5% Pectin | 10% Na-Caseinate | Yes |
| 5% carboxymethyl- | 10% Na-caseinate | Yes |
| cellulose | | |
| 5% Dextran | 10% NA-caseinate | No |

1. A polymer capsule comprising at least one polymer P1 and at least one microorganism M, wherein said polymer P1 has a solubility in water at 21° C. of at least 1 g/l and wherein said polymer capsule has an average particle size d90 of below 100 μm, wherein said microorganism M is distributed throughout said capsule.

2. The polymer capsule according to claim 1, wherein the number of cfu of said microorganism M is above 1E+08 cfu/g.

3. The polymer capsule according to claim 1, wherein said polymer capsule is not dispersed in any solvent.

4. The polymer capsule according to claim 1, wherein said microorganism M is sensitive to high shear forces and/or temperatures above 20° C. and/or non-aqueous chemical components or oils or reactive groups.

5. The polymer capsule according to claim 1, wherein said polymer P1 is selected from dextran, starch, alginate, pectin, gelatin, casein, polyvinyl alcohol, and polyvinylpyrrolidone or mixtures thereof.

6. The polymer capsule according to claim 1, wherein said polymer P1 has been subjected to solidification or crosslinking.

7. A formulation comprising at least one microorganism M, said formulation being a water in water emulsion, wherein said emulsion contains capsules of a polymer P1 dispersed in a continuous aqueous phase containing a polymer P2, wherein said polymer P1 has a solubility in water of at least 1 g/l at 21° C. and wherein said capsules further comprise said at least one microorganism M and wherein said polymer P2 has solubility in water of at least 1 g/l at 21° C., wherein polymer P1 and polymer P2 form an aqueous two-phase system.

8. The formulation according to claim 7, wherein said microorganism M is selected from gram-positive or gram-negative bacteria, spore forming bacteria, fungal spore, mycelia, yeasts, bacteriophages, or other viruses.

9. The formulation according to claim 7, wherein said polymers P1 and P2 are each selected from dextran, starch, alginate, guar gum, pectin, gelatin, casein, polyvinyl alcohol, polyvinylpyrrolidone, polyethylene glycol, caseinate, Maltodextrin, Carrageenan, dextran, xanthan gum, gum Arabic, or modified cellulose or mixtures thereof.

10. The formulation according to any of G claim 7, wherein said polymer P1 is selected from dextran, starch, alginate, guar gum, pectin, gelatin, casein, xanthan gum, polyvinyl alcohol, polyvinylpyrrolidone, modified cellulose, or mixtures thereof.

11. The formulation according to any of claim 7, wherein said polymers P1 and P2 are selected from the following combinations of polymer P1 and polymer P2:

| Polymer P1 | Polymer P2 |
|---|---|
| Dextran | Polyethylene glycol |
| Starch | Polyethylene glycol |
| Alginate | Caseinate |
| Alginate | Polyethylene glycol |
| Gelatin | Maltodextrin |
| Gelatin | Carrageenan |
| Gelatin | Modified cellulose like |
| | hydroxypropyl cellulose or |
| | carboxymethylcellulose |
| Gelatin | Dextran |
| Casein | Pectin |
| Gelatin | Gum Arabic |
| Polyvinyl alcohol | Polyethylene glycol |
| Polyvinyl alcohol | Polyvinylpyrrolidone |
| Polyvinylpyrrolidone | Polyethylene glycol |
| Guar gum | Polyethylene glycol |
| Guar gum | Polyvinylpyrrolidone |
| Xanthan gum | Polyethylene glycol |
| Modified cellulose like | Polyethylene glycol |
| hydroxypropyl cellulose or | |
| carboxymethylcellulose | |
| Modified cellulose like | Polyvinylpyrrolidone |
| hydroxypropyl cellulose or | |
| carboxymethylcellulose | |

12. The formulation according to any of claim 7, wherein said capsules have a number average diameter d₉₀ of 400 μm or less.

13. The formulation according to any of claim 7, wherein said polymer P1 has been subjected to solidification or crosslinking.

14. The formulation according to any of claim 7, wherein said polymer P1 has been subjected to a solidification or crosslinking induced by chemical crosslinking, or through temperature changes, pH changes, or by osmotic drying.

15. The formulation according to any of claim 7, wherein said polymer P1 has been subjected to solidification or crosslinking induced by temperature changes and/or an agent A, said agent A being selected from divalent cations, bases, aldehydes, enzymes genipin, carbodiimides, succinimides borates, titanates, zirconates, a modified cellulose, polyvinyl alcohol, and cyanoborohydrides.

16. A process for preparing capsules C comprising a polymer P1 and a substrate, wherein said polymer P1 has a solubility in water of at least 1 g/l at 21° C. comprising:
A) providing a droplet phase, said droplet phase being an aqueous solution of polymer P1 and further comprising a substrate dispersed in the aqueous medium;
B) providing a continuous phase, said continuous phase being an aqueous solution of a polymer P2, optionally further comprising an emulsifier;
C) bringing said droplet phase and said continuous phase into contact through the pores of a membrane while otherwise being separated by such membrane,
D) creating a flow of said droplet phase into said continuous phase through the pores of said membrane,
wherein said polymer P2 has solubility in water of at least 1 g/l at 21° C., wherein polymer P1 and polymer P2 form an aqueous two-phase system.

17. The process according to claim 16, wherein said substrate is a microorganism M.

18. The process according to claim 16, wherein the pores of said membrane have a number average pore size of 5 to 400 μm, preferably 5 to 100 μm.

19. The process according to claim 16, wherein the capsules obtained in step D) are physically separated from the continuous phase and optionally dried.

20. The process according to claim 16, wherein said continuous phase further comprises a solidifying agent A.

21. A method of controlling phytopathogenic fungi and/or undesired plant growth and/or undesired insect or mite attack and/or for regulating the growth of plants, wherein the capsules according to claim 1 are allowed to act on the respective pests, their environment or the crop plants to be protected from the respective pest, on the soil and/or on undesired plants and/or on the crop plants and/or on their environment.
